(19) United States
(12) Patent Application Publication
(10) Pub. No.: US 2020/0258698 A1
(43) Pub. Date: Aug. 13, 2020

(54) KEY CAP STRUCTURE

(71) Applicant: TAI-SHENG HAN, New Taipei (TW)

(72) Inventor: TAI-SHENG HAN, New Taipei (TW)

(21) Appl. No.: 16/273,164

(22) Filed: Feb. 12, 2019

(51) Int. Cl. H01H 13/83; H01H 13/88; G06F 3/02; G06F 1/16

(52) U.S. Cl. CPC H01H 13/83; H01H 13/88; H01H 2219/054; G06F 1/1662; H01H 2221/07; G06F 3/0216

(57) ABSTRACT

The present invention provides a key cap structure comprising a first key and a light transmissive body and a second key. At a side of the first key is formed with a bearing bevel and a side opening. The light transmissive body is disposed on the bearing bevel, the second key is disposed on the light transmissive body, and the first key and the light transmissive body and the second key are formed with different materials by injection molding. In this way, dissimilar materials of the key cap structure can be distinguished by colors or transparently, thereby achieving the efficacies of a variety of various materials and lighting effects.

### BACKGROUND OF THE INVENTION

### Field of Invention

The present invention relates to a key cap, and more particularly a key cap structure that produces a variety of various materials and lighting effects.

### Related Art

According to the continuous development and advancement of technology and information, the use of computer equipment and its peripheral devices has become quite common. Taking notebook computer as an example, keyboard has been widely used in the interface control of notebook computer and has become a necessary hardware peripheral device, while the conventional keyboard is mainly composed of a plurality of keys, which respectively represent different letters, numbers and symbols. However, for the keyboard keys commonly used in the market, the pattern (such as texts or symbols, etc.) of each key cap is usually printed directly on the key cap, and is mainly based on the traditional square four-corner key cap with design of plastic front side, so the key caps can only be presented in a monotonous color, such as black or other colors; even if the design with a backlight device disposing under the key cap to emit light to the key cap, it can only produce a monochromatic illumination effect on the pattern, often without design sense and variability, thus the competitiveness of products in the market can not be enhanced. Therefore, how to provide different keyboard designs among multiple choices to increase attractiveness and the attention of consumers is one of the topics the related industry endeavors to solve.

Therefore, how to improve the above-mentioned drawbacks and problems is the technical difficulty that the inventor of the present invention wants to solve.

### SUMMARY OF THE INVENTION

Therefore, in order to effectively solve the above problems, a main object of the present invention is to provide a key cap structure that can produce a variety of various materials and lighting effects.

In order to achieve the above object, the present invention provides a key cap structure comprising a first key and a light transmissive body and a second key, wherein on the first key is formed with a key top, at sides are formed with a plurality of key skirts, and at a side of the first key is formed with a bearing bevel, the bearing bevel is formed at joints of the key top and the key skirts; the first key is formed with a side opening, and the side opening is formed at a middle of the bearing bevel; and the light transmissive body is disposed on the bearing bevel, the second key is disposed on the light transmissive body, and the first key and the light transmissive body and the second key are formed with different materials by injection molding. In this way, dissimilar materials of the key cap structure can be distinguished by colors or transparently, thereby achieving the efficacies of a variety of various materials and lighting effects.

According to an embodiment of the key cap structure of the present invention, wherein the first key is injection molded from a non-transparent thermoplastic polymer material.

According to an embodiment of the key cap structure of the present invention, wherein the non-transparent thermoplastic polymer material is an ABS resin.

According to an embodiment of the key cap structure of the present invention, wherein the light transmissive body is injection molded from a light transmissive thermoplastic polymer material, and the first key and the light transmissive body are formed with different materials by injection molding.

According to an embodiment of the key cap structure of the present invention, wherein the second key is injection molded from a non-transparent thermoplastic polymer material, and the second key and the light transmissive body are formed with different materials by injection molding, or the second key is attached on the light transmissive body.

According to an embodiment of the key cap structure of the present invention, wherein the non-transparent thermoplastic polymer material of the second key is a thermoplastic polyurethane elastomer or a thermoplastic elastomer.

According to an embodiment of the key cap structure of the present invention, wherein the light transmissive body has at least one connecting arm and one fulcrum shaft extending from a side opposite to the side opening, and the light transmissive body has at least one extending arm at another side of the fulcrum shaft opposite to the connecting arm, wherein one end of the connecting arm is connected to the fulcrum shaft, and another end is connected to an inner side of the key skirt and the light transmissive body, and one end of the extending arm is connected to the fulcrum shaft, and another end is connected to the inner side of the key skirt.

According to an embodiment of the key cap structure of the present invention, wherein the key top is formed with a hollow portion, the light transmissive body is formed with a marking portion at a position of the hollow portion, and the marking portion is relatively formed between the extending arms and assembled in the hollow portion.

### BRIEF DESCRIPTION OF THE DRAWINGS

FIG. 1 is a perspective assembled view of a preferred embodiment of the present invention;

FIG. 2 is a perspective exploded view of the preferred embodiment of the present invention;

FIG. 3 is a schematic diagram viewed from another angle of the preferred embodiment of the present invention;

FIG. 4 is a first schematic diagram of the implementation of the preferred embodiment of the present invention; and

FIG. 5 is a second schematic diagram of the implementation of the preferred embodiment of the present invention.

### DETAILED DESCRIPTION OF THE INVENTION

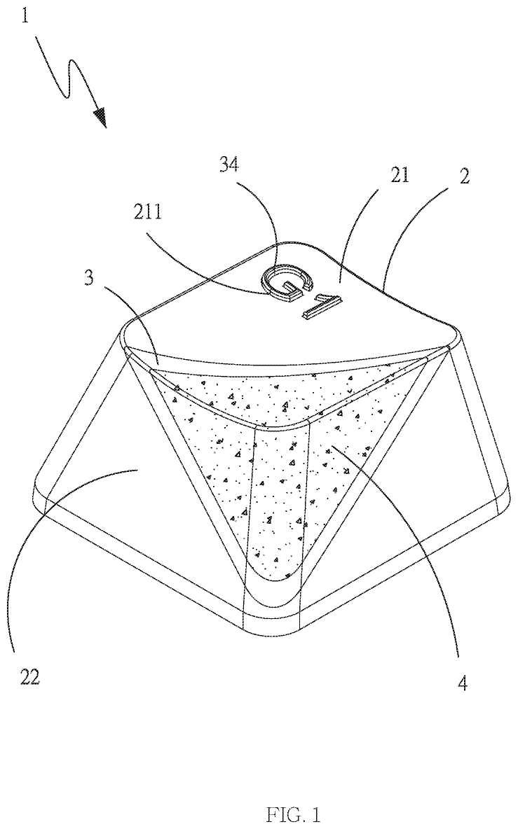

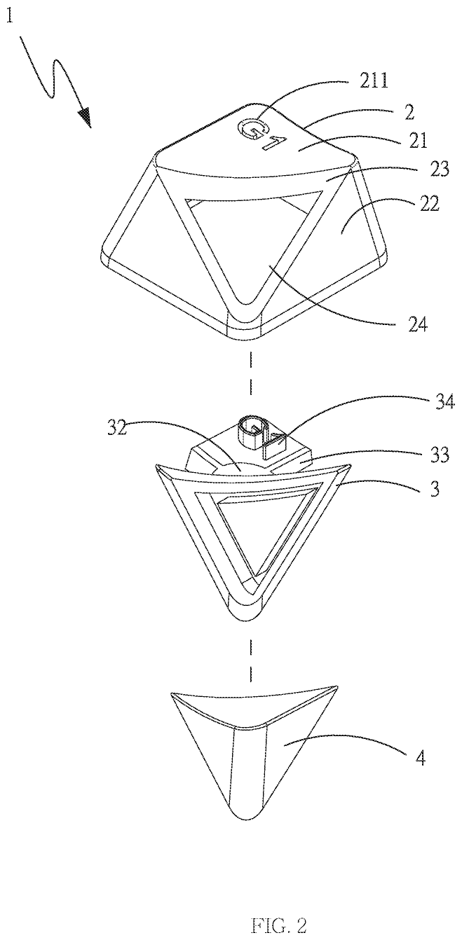

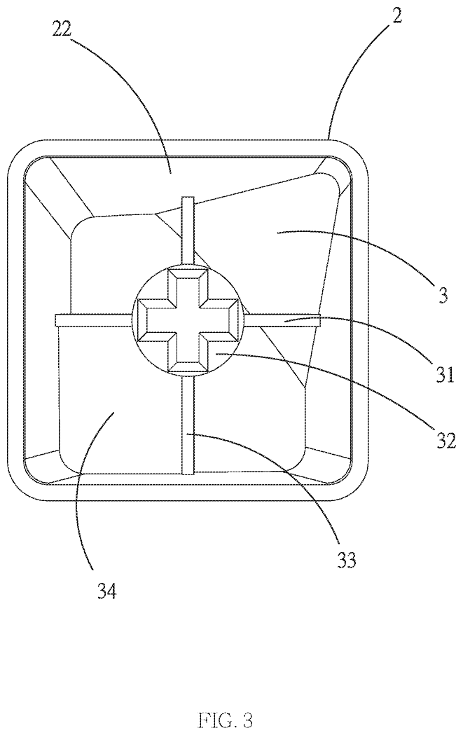

Please refer to FIG. 1 and FIG. 2 and FIG. 3, which are perspective assembled view, perspective exploded and schematic diagram viewed from another angle of the preferred embodiment of the present invention. It can be clearly seen from the figures that, a key cap structure 1 of the present invention comprises a first key 2, a light transmissive body 3 and a second key 4. The first key 2 is formed with a key top 21 at a top position, and the key top 21 is formed with a hollow portion 211. The first key 2 is formed with a plurality of key skirts 22 at side positions, and the first key 2 is formed with a bearing bevel 23 at a side position. The bearing bevel 23 is formed at joints of the key top 21 and the key skirts 22, and the bearing bevel 23 extends from the key top 21 downwardly toward the key skirts 22 in a slope manner. The first key 2 further has a side opening 24, the first key 2 is injection molded from a non-transparent thermoplastic polymer material, and the non-transparent thermoplastic polymer material is an ABS resin.

The light transmissive body 3 is disposed on the bearing bevel 23, the light transmissive body 3 has at least one connecting arm 31 and one fulcrum shaft 32 extending from a side opposite to the side opening 24. The light transmissive body 3 has at least one extending arm 33 at another side of the fulcrum shaft 32 opposite to the connecting arm 31, wherein one end of the connecting arm 31 is connected to the fulcrum shaft 32, and another end is connected to an inner side of the key skirt 22 and the light transmissive body 3; one end of the extending arm 33 is connected to the fulcrum shaft 32, and another end is connected to the inner side of the key skirt 22; the light transmissive body 3 is formed with a marking portion 34 at a position of the hollow portion 211, and the marking portion 34 is relatively formed between the extending arms 33 and assembled in the hollow portion 211; the light transmissive body 3 is injection molded from a light transmissive thermoplastic polymer material, and the first key 2 and the light transmissive body 3 are formed with different materials by injection molding.

The second key 4 is disposed on the light transmissive body 3, the second key 4 is injection molded from a non-transparent thermoplastic polymer material, and the non-transparent thermoplastic polymer material of the second key 4 is a thermoplastic polyurethane elastomer or a thermoplastic elastomer. The second key 4 and the light transmissive body 3 can be formed with different materials by injection molding. The first key 2 and the light transmissive body 3 and the second key 4 are formed with different materials by injection molding, or the second key 4 can be attached on the light transmissive body 3 by means of adhesive bonding.

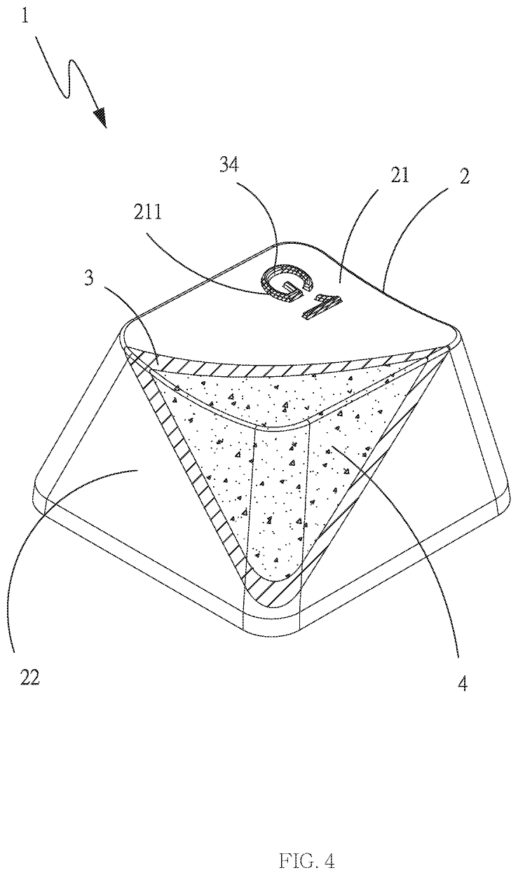

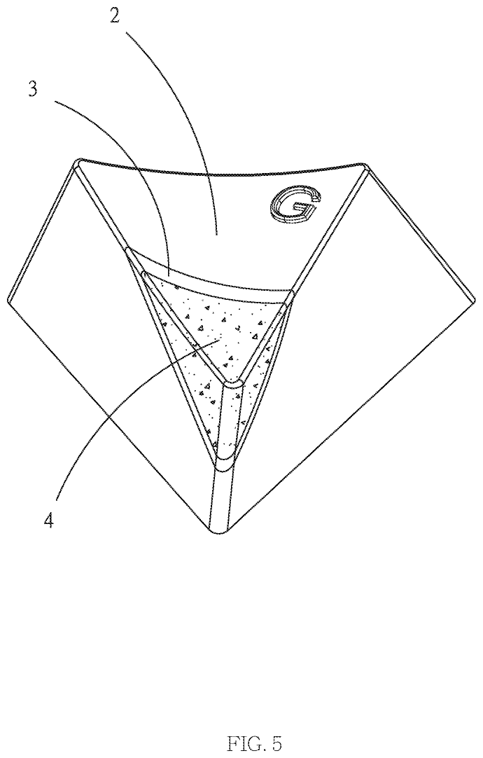

Please refer to the foregoing drawings and FIGS. 4 and 5, which are first and second schematic diagrams of the implementation of the preferred embodiment of the present invention. It can be clearly seen from the figures that, dissimilar materials of the key cap structure 1 can be distinguished by colors or transparently by forming the first key 2 and the light transmissive body 3 and the second key 4 with different materials by injection molding; and dissimilar materials of the key cap structure 1 can be distinguished by colors or transparently by forming the first key 2 and the light transmissive body 3 with different materials by injection molding, and by forming the second key 4 by injection molding and adhering on the light transmissive body 3. At the same time, when a light-emitting member under the key cap structure 1 generates a light source, the light source passes through bottoms of the first key 2 and the second key 4, and is emitted from the light transmissive body 3 and the marking portion 34, and the first key 2 and the second key 4 effectively shield the light source, so that the key cap structure 1 can achieve the efficacies of a variety of various materials and lighting effects. Injection molding with different materials or adhesive molding of the first key 2 and the light transmissive body 3 and the second key 4 of the key cap structure 1 can be performed based on the characteristics of a plane formed by three points or more, so that the key cap structure 1 can be presented in a triangular or a polygonal shape, etc., and in the present embodiment, a triangle is used as the implementation, but it is not limited thereto.

It is to be understood that the above description is only preferred embodiments of the present invention and is not used to limit the present invention, and changes in accordance with the concepts of the present invention may be made without departing from the spirit of the present invention, for example, the equivalent effects produced by various transformations, variations, modifications and applications made to the configurations or arrangements shall still fall within the scope covered by the appended claims of the present invention.

What is claimed is:

1. A key cap structure, comprising:
a first key, the first key having a key top and a plurality of key skirts, the first key being formed with a bearing bevel at joints of the key top and the key skirts, and the first key being formed with a side opening at a middle of the bearing bevel;
a light transmissive body, the light transmissive body being disposed on the bearing bevel; and
a second key, the second key being disposed on the light transmissive body.

2. The key cap structure as claimed in claim 1, wherein the first key is injection molded from a non-transparent thermoplastic polymer material.

3. The key cap structure as claimed in claim 2, wherein the non-transparent thermoplastic polymer material is an ABS resin.

4. The key cap structure as claimed in claim 2, wherein the light transmissive body is injection molded from a light transmissive thermoplastic polymer material, and the first key and the light transmissive body are formed with different materials by injection molding.

5. The key cap structure as claimed in claim 4, wherein the second key is injection molded from a non-transparent thermoplastic polymer material, and the second key and the light transmissive body are formed with different materials by injection molding, or the second key is attached on the light transmissive body.

6. The key cap structure as claimed in claim 5, wherein the non-transparent thermoplastic polymer material of the second key is a thermoplastic polyurethane elastomer or a thermoplastic elastomer.

7. The key cap structure as claimed in claim 1, wherein the light transmissive body has at least one connecting arm and one fulcrum shaft extending from a side opposite to the side opening, and the light transmissive body has at least one extending arm at another side of the fulcrum shaft opposite to the connecting arm, wherein one end of the connecting arm is connected to the fulcrum shaft, and another end is connected to an inner side of the key skirt and the light transmissive body, and one end of the extending arm is connected to the fulcrum shaft, and another end is connected to the inner side of the key skirt.

8. The key cap structure as claimed in claim 7, wherein the key top is formed with a hollow portion, the light transmissive body is formed with a marking portion at a position of the hollow portion, and the marking portion is relatively formed between the extending arms and assembled in the hollow portion.
